(19) United States
(12) Patent Application Publication
(10) Pub. No.: US 2026/0233657 A1
(43) Pub. Date: Aug. 13, 2026

(54) OFF-ROAD TRACKED VEHICLE

(71) Applicant: GM Global Technology Operations LLC, Detroit, MI (US)

(72) Inventor: Garrick C. Zack, Troy, MI (US)

(73) Assignee: GM Global Technology Operations LLC, Detroit, MI (US)

(21) Appl. No.: 19/050,624

(22) Filed: Feb. 11, 2025

(51) Int. Cl. B60P 1/38; B60G 17/00; B62D 11/04; B62D 55/06; B62D 55/10; B62D 55/14

(52) U.S. Cl. CPC B60P 1/38; B60G 17/00; B62D 11/04; B62D 55/06; B62D 55/10; B62D 55/14; B60G 2500/30

(57) ABSTRACT

A tracked vehicle includes a cargo box having a bed extending between a first edge and a second edge with respect to a first axis and between a first side and a second side with respect to a second axis that is perpendicular to the first axis, a first side wall coupled to the first side of the bed and extending between the first edge and the second edge, and a second side wall coupled to the second side of the bed and extending between the first edge and the second edge. A conveyor is coupled to the bed and extends between the first edge and the second edge and between the first side and the second side. The tracked vehicle further includes a suspension and propulsion system coupled to the cargo box.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a tracked vehicle.

Vehicles equipped with treaded tracks, often referred to as tracked vehicles, are designed to traverse a wide range of terrains with enhanced stability and traction. Unlike traditional wheeled vehicles, tracked vehicles distribute their weight more evenly across a larger surface area, reducing ground pressure and allowing them to move efficiently over soft, uneven, flat, or rugged surfaces such as mud, snow, sand, and rocky landscapes. The continuous tracks, typically made of durable materials like rubber or metal, provide superior grip and prevent the vehicle from sinking or getting stuck in a variety of environments. Further development and utilization of tracked vehicles are possible and will be discussed in accordance with principles of the present disclosure.

### SUMMARY

In one configuration, a tracked vehicle is provided and includes a cargo box having a bed extending between a first edge and a second edge with respect to a first axis and between a first side and a second side with respect to a second axis that is perpendicular to the first axis, a first side wall coupled to the first side of the bed and extending between the first edge and the second edge, and a second side wall coupled to the second side of the bed and extending between the first edge and the second edge. A conveyor is coupled to the bed and extends between the first edge and the second edge and between the first side and the second side. The tracked vehicle further includes a suspension and propulsion system coupled to the cargo box.

The tracked vehicle may include one or more of the following optional aspects. For example, the first side wall can include a first proximal end coupled to the first side of the bed and a first distal end spaced from the first proximal end with respect to a third axis that is perpendicular to the first axis and the second axis, and the second side wall can include a second proximal end coupled to the second side of the bed and a second distal end spaced from the second proximal end with respect to the third axis. A first well guard can be coupled to the first distal end of the first side wall and extend between the first edge and the second edge, and a second well guard can be coupled to the second distal end of the second side wall and extend between the first edge and the second edge.

According to at least one aspect, the first side wall can include a first front portion and a first rear portion that are spaced from one another with respect to the first axis and extend between the first proximal end and the first distal end, and the second side wall can include a second front portion and a second rear portion that are spaced from one another with respect to the first axis and extend between the second proximal end and the second distal end. The first front portion and the first rear portion can be tapered between the first proximal end and the first distal end, and the second front portion and the second rear portion can be tapered between the second front portion and the second rear portion.

According to another aspect, the first side wall and the second side wall can be parallel to one another.

According to at least one example, the conveyor can be configured to move objects in a first direction and a second direction that is opposite of the first direction. The first direction extends from the first edge toward the second edge with respect to the first axis, and the second direction extends from the second edge toward the first edge with respect to the first axis.

According to at least one aspect, the first edge guides objects toward an object-receiving area defined by the first side wall, the second side wall, and the bed. The second edge guides objects toward the object-receiving area.

In another configuration, a tracked vehicle is provided and includes a cargo box having a first edge and a second edge spaced from the first edge with respect to a first axis and a first track assembly and a second track assembly coupled to the cargo box, the first track assembly and the second track assembly each including a frame coupled to the cargo box, one or more wheels coupled to the frame, and a track arranged on and movable with respect to the wheels. One or more actuators are arranged between the cargo box and the frame.

The tracked vehicle may include one or more of the following optional aspects. For example, the cargo box can be movable between a first position and a second position. The first edge and the second edge may be equally spaced from a ground surface in the first position. The first edge may be arranged closer to the ground surface than the second edge in the second position.

According to at least one aspect, the first track assembly and the second track assembly each include a motor coupled to at least one of the one or more wheels. The motors drive at least one of the one or more wheels in a first direction or a second direction opposite of the first direction. The motor of the first track assembly is controlled independently from the motor of the second track assembly.

According to another aspect, the cargo box includes a first front portion and a first rear portion spaced from the first front portion with respect to a second axis that is perpendicular to the first axis, and a second front portion and a second rear portion spaced from the second front portion with respect to the second axis. The actuators can include front actuators that are arranged adjacent to the first front portion and the second front portion and rear actuators that are arranged adjacent to the first rear portion and the second rear portion. The front actuators and the rear actuators are movable between a retracted position and a deployed position, the front actuators being movable independent of the rear actuators.

### BRIEF DESCRIPTION OF THE DRAWINGS

The drawings described herein are for illustrative purposes only of selected configurations and are not intended to limit the scope of the present disclosure.

FIG. 1 is a perspective view of a tracked vehicle according to principles of the present disclosure;

FIG. 2 is a front perspective view of the tracked vehicle of FIG. 1;

FIG. 3 is a top view of the tracked vehicle of FIG. 1;

FIG. 4 is a bottom view of the tracked vehicle of FIG. 1;

FIG. 5 is a side view of the tracked vehicle of FIG. 1 having a cargo box in a first position; and

FIG. 6 is a side view of the tracked vehicle of FIG. 1 having the cargo box in a second position.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

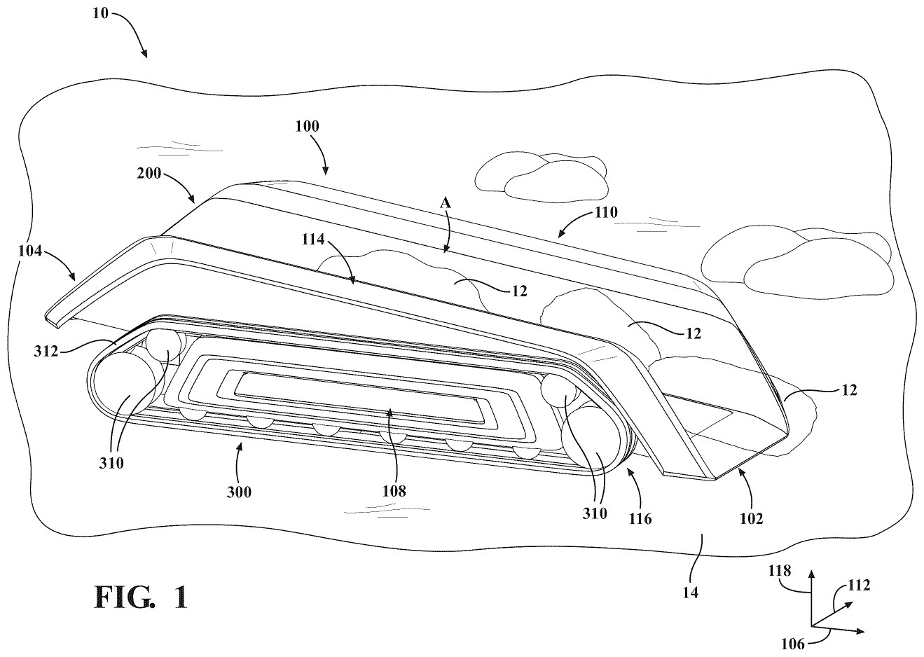

With reference to FIG. 1, an illustrative example of a tracked vehicle 100 is provided and arranged in an operating environment 10. The tracked vehicle 100 can be configured to traverse throughout the operating environment 10 as well as manipulate and move objects 12 arranged in the operating environment 10, such as dirt, boulders, stones, etc. Note, the tracked vehicle 100 can also carry objects that are normally found in manufacturing and/or industrial environments.

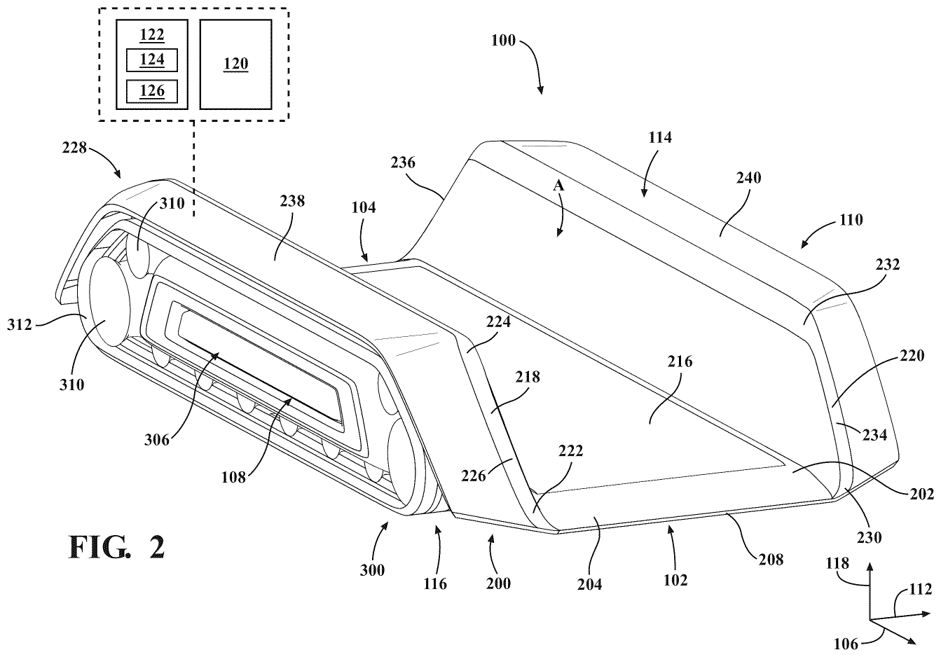

With reference to FIGS. 1 and 2, the tracked vehicle 100 includes a first end 102 and a second end 104 that is spaced from the first end 102 with respect to a first or longitudinal axis 106, a first side 108 and a second side 110 spaced from the first side 108 with respect to a second or lateral axis 112, and an upper end 114 and a lower end 116 spaced from the upper end 114 with respect to a third or vertical axis 118. The longitudinal, lateral, and vertical axes 106, 112, 118 are perpendicular to one another. The tracked vehicle 100 includes a cargo box 200 extending between the first end 102 and the second end 104 and a suspension and propulsion system 300 coupled to the cargo box 200.

The tracked vehicle 100 can include one or more power reservoirs (i.e., a rechargeable battery) 120 that supply power to the suspension and propulsion system 300 and to a vehicle management system 122. The vehicle management system 122 can include a communication system (i.e., computing hardware and memory hardware) 124 and a sensor system 126. The vehicle management system 122 enables navigation and operation of the tracked vehicle 100 for autonomous and/or remote movement throughout the operating environment 10. More particularly, the vehicle management system 122 can rely on sensor data, algorithms, and/or artificial intelligence to help navigate throughout the operating environment 10. According to one aspect, remote or autonomous movement of the tracked vehicle 100 can be desirable for eliminating direct physical intervention of a human to load the objects 12 within the operating environment 10. According to another aspect, the vehicle management system 122 can be configured to communicate with neighboring tracked vehicles 100 so that several of the tracked vehicles 100 can be synchronously controlled within the operating environment 10.

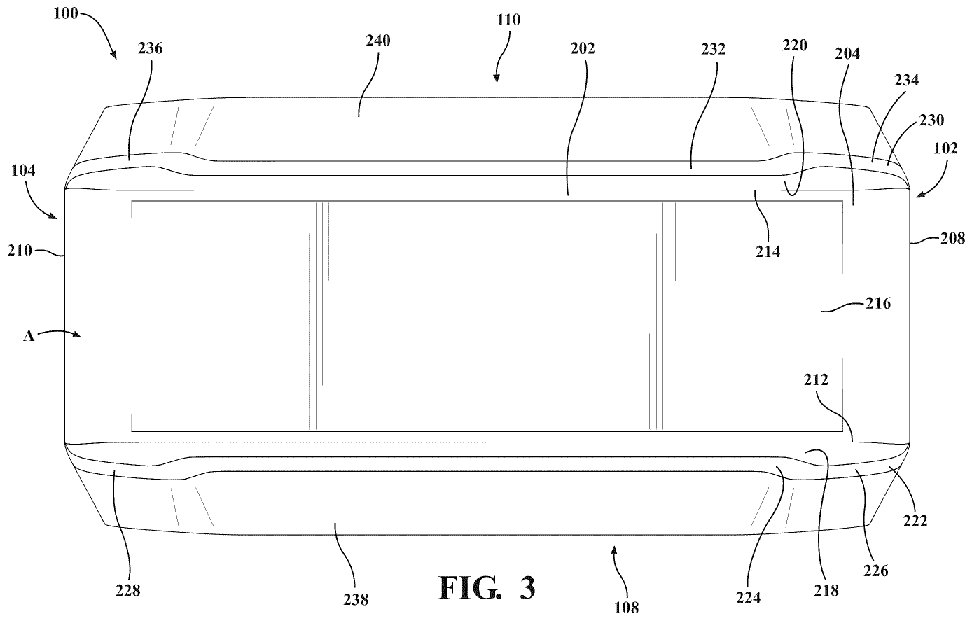

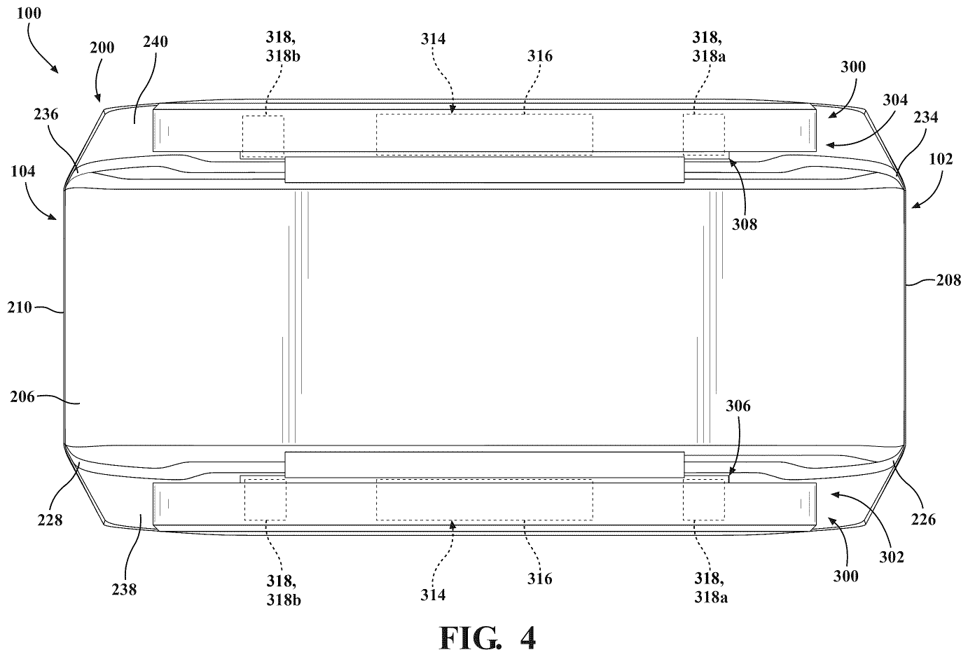

With reference to FIG. 2, an illustrative example of the cargo box 200 is provided and is configured to receive one or more of the objects 12 (FIG. 1). The cargo box 200 can extend between the first end 102 and the second end 104 with respect to the longitudinal axis 106 and between the first side 108 and the second side 110 with respect to the lateral axis 112. In the present illustrative configuration, the cargo box 200 includes a bed 202 that has an upper side 204 and a lower side 206 (FIG. 4) that is opposite of the of the upper side 204. The bed 202 includes a first or front edge 208, a second or rear edge 210 (FIG. 3) spaced from the front edge 208 with respect to the longitudinal axis 106, a first side 212, and a second side 214 spaced from the first side 212 with respect to the lateral axis 112. According to one aspect, the front edge 208 and/or the rear edge 210 can be configured to engage with objects 12 arranged in the operating environment 10 and guide the objects onto the cargo box 200. The first side 212 and the second side 214 each extend between the front edge 208 and the rear edge 210. According to one aspect, the front edge 208 can define at least a portion of the first end 102 of the tracked vehicle 100 and the rear edge 210 can define at least a portion of the second end 104 of the tracked vehicle 100. The front edge 208 and the rear edge 210 can be configured to contact a ground surface 14 upon which the tracked vehicle 100 is positioned. In other words, the front edge 208 and/or the rear edge 210 can be made of a metal material or another durable material so that the edges 208, 210 can routinely contact the ground surface 14 to engage with the one or more objects 12 arranged within the operating environment 10. According to one aspect, the front edge 208 and the rear edge 210 can be desirable for self-loading (i.e., without direct physical human intervention) one or more of the objects 12 onto the bed 202 of the the cargo box 200, as well as offloading one or more of the objects 12 from the bed 202 into the operating environment 10. The front edge 208 and/or the rear edge 210 can also be desirable to guide the objects 12 onto a conveyor belt (i.e., conveyor) 216 arranged in the bed 202 between the front edge 208 and the rear edge 210 and between a first side wall 218 coupled to the first side 212 and a second side wall 220 coupled to the second side 214. The conveyor belt 216 can be bi-directional so that the objects 12 (FIG. 1) can be loaded at the first end 102 and moved toward the second end 104 or loaded at the second end 104 and moved toward the first end 102.

The first side wall 218 includes a first proximal end 222 coupled to the first side 212 and a first distal end 224 spaced from the first proximal end 222 with respect to the vertical axis 118. The first side wall 218 includes a first front portion 226 and a first rear portion 228 spaced from the first front portion 226 with respect to the longitudinal axis 106. One or both of the first front portion 226 and the first rear portion 228 can be tapered between the first distal end 224 and the first proximal end 222. The second side wall 220 includes a second proximal end 230 coupled to the second side 214 and a second distal end 232 spaced from the second proximal end 230 with respect to the vertical axis 118. The second side wall 220 includes a second front portion 234 and a second rear portion 236 spaced from the second front portion 234 with respect to the longitudinal axis 106. One or both of the second front portion 234 and the second rear portion 236 can be tapered between the second distal end 232 and the second proximal end 230.

According to one aspect, with reference to FIG. 3, the first side wall 218 and the second side wall 220 can be arranged parallel to one another. In other configurations, the first side wall 218 and the second side wall 220 can depend away from each other or can be otherwise arranged to provide lateral support for the one or more objects 12 arranged on the bed 202 of the cargo box 200. According to another aspect, the first side wall 218, the second side wall 220, and the bed 202 define an object-receiving area A that is configured to receive and retain one or more of the objects 12 arranged in the operating environment 10.

With reference again to FIG. 2, the cargo box 200 can include well guards coupled to the first side wall 218 and the second side wall 220. In the present illustrative configuration, a first well guard 238 is coupled to the first distal end 224 of the first side wall 218 and extends between the first front portion 226 and the first rear portion 228. Likewise, a second well guard 240 is coupled to second distal end 232 of the second side wall 220 and extends between the second front portion 234 and the second rear portion 236. The first and second well guards 238, 240 and the first and second side walls 218, 220 respectively form partially enclosed chambers that are configured to house and protect a portion of the suspension and propulsion system 300.

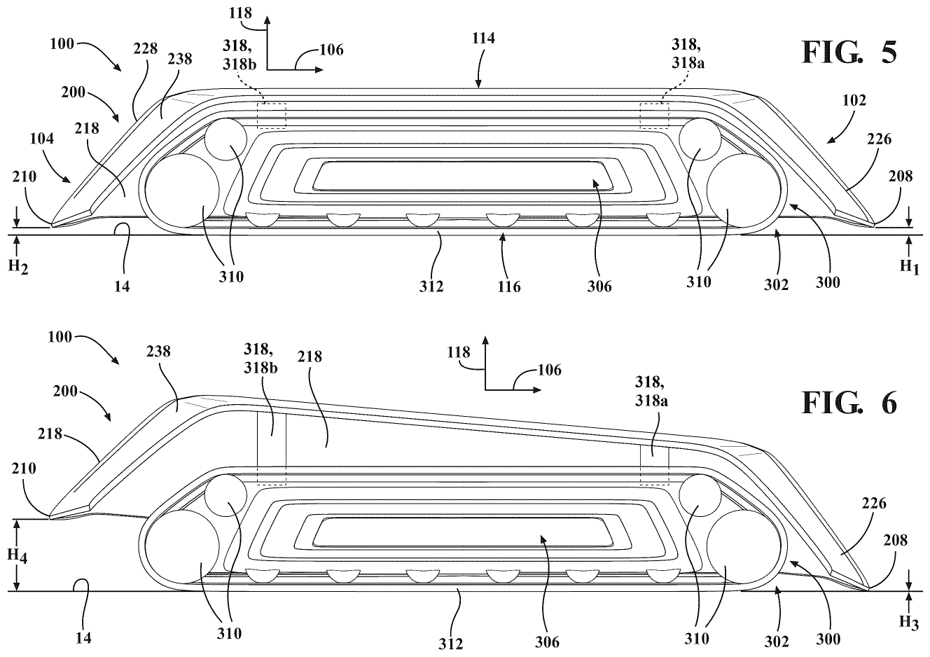

With reference to FIG. 4, the suspension and propulsion system 300 includes a first track assembly 302 that is coupled to the cargo box 200 and defines a portion of the first side 108 of the tracked vehicle 100. Similarly, the suspension and propulsion system 300 includes a second track assembly 304 that is coupled to the cargo box 200 and defines a portion of the second side 110 of the tracked vehicle 100. The first track assembly 302 includes a first frame 306 arranged adjacent to the first side wall 218 and coupled to the cargo box 200 and the second track assembly 304 includes a second frame 308 arranged adjacent to the second side wall 220 and coupled to the cargo box 200, as shown in FIG. 4. According to one aspect, the first frame 306 and the second frame 308 can include one or more shocks, springs, etc. that allow the frames 306, 308 to accommodate different terrain in the operating environment 10. With reference to FIGS. 4 and 5, the first track assembly 302 further includes one or more wheels or gears 310 coupled to the first frame 306. A track 312 can be arranged on and can be movable with respect to the one or more wheels 310. The second track assembly 304 can be arranged in a similar manner as the first track assembly 302. The tracks 312 can be made of a rubber or a metal material and can be configured to be driven by one or more of the wheels 310. For instance, the wheels 310 of each of the track assemblies 302, 304 can include one toothed wheel that corresponds with openings in the track 312 and is responsible for driving the tracks 312 in a first direction (i.e., forward) or in a second direction (i.e., reverse). According to one aspect, the tracks 312 can be arranged on the tracked vehicle 100 so that the tracks 312 do not cause damage or significantly disrupt the terrain that it contacts within the operating environment 10.

The tracked vehicle 100 can further include one or more drive units 314 that are arranged in the first track assembly 302 and the second track assembly 304 and are responsible for driving the tracks 312 about the wheels 310. Each drive unit 314 can include an electric motor 316 that is communicatively coupled to the power reservoir 120 and coupled to at least one of the wheels 310, as shown in FIG. 2.

With reference to FIG. 4, the suspension and propulsion system 300 can further include one or more actuators 318 that are configured to adjust the height of the cargo box 200 with respect to the ground surface 14 of the operating environment 10. The actuators 318 can be hydraulic actuators or another type of actuator. According to one aspect, the actuators 318 can be coupled to an underside of the cargo box 200 and/or to a portion of the frames 306, 308 of the track assemblies 302, 304. In the present illustrative configuration, the actuators 318 include front actuators 318a arranged adjacent to the first front portion 226 and the second front portion 234 and rear actuators 318b arranged adjacent to the first rear portion 228 and the second rear portion 236. Note, in other configurations, the tracked vehicle 100 may include more or less (e.g., zero, one, two, three, or n-number) of the actuators 318, 318a, 318b.

The actuators 318 can be communicatively coupled to the vehicle management system 122 and configured to be controlled (i.e., actuated and/or retracted) by the vehicle management system 122. The cargo box 200 can be arranged in a first position (FIG. 5) when the front actuators 318a and the rear actuators 318b are retracted (i.e., not deployed). In other words, the front edge 208 of the cargo box 200 can be positioned at a first height H1 from the ground surface 14 and the rear edge 210 of the cargo box 200 can be positioned at a second height H2 from the ground surface 14. In the first position (FIG. 5), the first height HI and the second height H2 are about equal to one another. According to one aspect, the tracked vehicle 100 has a low center of gravity in the first position (FIG. 5) and, thus, can be desirable when transporting one or more of the objects 12 throughout the operating environment 10.

The cargo box 200 can be arranged in a second position (FIG. 6) when one or more of the rear actuators 318b are deployed. In the second position (FIG. 6), the front edge 208 of the cargo box 200 can be arranged at a third height H3 from the ground surface 14 and the rear edge 210 of the cargo box 200 can be position at a fourth height H4. As shown in FIG. 6, the fourth height H4 is greater than the third height H3. When the cargo box 200 is in the second position (FIG. 6), the conveyor belt 216 can be used to move one or more of the objects 12 from the ground surface 14 to an elevated surface such as a bed of a pickup truck, for example. The second position (FIG. 6) also allows the tracked vehicle to easily scoop dirt or debris onto the cargo box 200. Other combinations or arrangements of the front actuators 318a and the rear actuators 318b are possible and can be desirable for scooping, lifting, and/or moving oddly weighted and/or mis-shaped cargo with precision in off-road locations.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A tracked vehicle, comprising:
a cargo box, comprising:
a bed extending between a first edge and a second edge with respect to a first axis and between a first side and a second side with respect to a second axis that is perpendicular to the first axis,
a first side wall coupled to the first side of the bed and extending between the first edge and the second edge,
a second side wall coupled to the second side of the bed and extending between the first edge and the second edge, and
a conveyor coupled to the bed and extending between the first edge and the second edge and between the first side and the second side; and
a suspension and propulsion system coupled to the cargo box.

2. The tracked vehicle of claim 1, wherein the first side wall includes a first proximal end coupled to the first side of the bed and a first distal end spaced from the first proximal end with respect to a third axis that is perpendicular to the first axis and the second axis, and the second side wall includes a second proximal end coupled to the second side of the bed and a second distal end spaced from the second proximal end with respect to the third axis.

3. The tracked vehicle of claim 2, wherein a first well guard is coupled to the first distal end of the first side wall and extends between the first edge and the second edge, and a second well guard is coupled to the second distal end of the second side wall and extends between the first edge and the second edge.

4. The tracked vehicle of claim 2, wherein the first side wall includes a first front portion and a first rear portion that are spaced from one another with respect to the first axis and extend between the first proximal end and the first distal end, and the second side wall includes a second front portion and a second rear portion that are spaced from one another with respect to the first axis and extend between the second proximal end and the second distal end.

5. The tracked vehicle of claim 4, wherein the first front portion and the first rear portion are tapered between the first proximal end and the first distal end, and the second front portion and the second rear portion are tapered between the second front portion and the second rear portion.

6. The tracked vehicle of claim 1, wherein the first side wall and the second side wall are parallel to one another.

7. The tracked vehicle of claim 1, wherein the conveyor is configured to move objects in a first direction and a second direction that is opposite of the first direction.

8. The tracked vehicle of claim 7, wherein the first direction extends from the first edge toward the second edge with respect to the first axis, and the second direction extends from the second edge toward the first edge with respect to the first axis.

9. The tracked vehicle of claim 1, wherein the first edge guides objects toward an object-receiving area defined by the first side wall, the second side wall, and the bed.

10. The tracked vehicle of claim 9, wherein the second edge guides objects toward the object-receiving area.

11. A tracked vehicle, comprising:
a cargo box including a first edge and a second edge spaced from the first edge with respect to a first axis;
a first track assembly and a second track assembly coupled to the cargo box, the first track assembly and the second track assembly each comprising:
a frame coupled to the cargo box,
one or more wheels coupled to the frame, and
a track arranged on and movable with respect to the wheels; and
one or more actuators arranged between the cargo box and the frame.

12. The tracked vehicle of claim 11, wherein the cargo box is movable between a first position and a second position.

13. The tracked vehicle of claim 12, wherein the first edge and the second edge are equally spaced from a ground surface in the first position.

14. The tracked vehicle of claim 13, wherein the first edge is arranged closer to the ground surface than the second edge in the second position.

15. The tracked vehicle of claim 11, wherein the first track assembly and the second track assembly each include a motor coupled to at least one of the one or more wheels.

16. The tracked vehicle of claim 15, wherein the motors drive at least one of the one or more wheels in a first direction or second direction opposite of the first direction.

17. The tracked vehicle of claim 16, wherein the motor of the first track assembly is controlled independently from the motor of the second track assembly.

18. The tracked vehicle of claim 11, wherein the cargo box includes a first front portion and a first rear portion spaced from the first front portion with respect to a second axis that is perpendicular to the first axis, and a second front portion and a second rear portion spaced from the second front portion with respect to the second axis.

19. The tracked vehicle of claim 18, wherein the actuators include front actuators that are arranged adjacent to the first front portion and the second front portion and rear actuators that are arranged adjacent to the first rear portion and the second rear portion.

20. The tracked vehicle of claim 19, wherein the front actuators and the rear actuators are movable between a retracted position and a deployed position, the front actuators being movable independent of the rear actuators.
